(19) United States
(12) Patent Application Publication
(10) Pub. No.: US 2012/0260295 A1
(43) Pub. Date: Oct. 11, 2012

(54) Wireless Audio Dissemination System

(75) Inventor: Christopher J. Rondeau, Hampton Falls, NH (US)

(73) Assignee: PLANETMAC, LLC, Newington, NH (US)

(21) Appl. No.: 13/440,738

(22) Filed: Apr. 5, 2012

Related U.S. Application Data
(60) Provisional application No. 61/471,985, filed on Apr. 5, 2011.

(51) Int. Cl. H04N 21/61

(52) U.S. Cl. 725/62

(57) ABSTRACT

A wireless audio dissemination system includes a plurality of television monitors configured to display video content from a media source coupled thereto. The system further includes a plurality of transmitters coupled to an associated one of the plurality of television monitors and configured to propagate a wireless broadcast stream including audio content corresponding to video content displayed on the associated television monitor. At least one mobile device is configured to wirelessly communicate and receive the broadcast stream from each of the plurality of transmitters and allow a user to selectively receive the associated audio content from one of the plurality of transmitters.

### CROSS-REFERENCE TO RELATED APPLICATIONS

The present non-provisional application claims the benefit of U.S. Provisional Patent Application Ser. No. 61/471,985, filed Apr. 5, 2011, the entire disclosure of which is incorporated herein by reference.

### FIELD

The present disclosure relates generally to audio dissemination systems, and, more particularly, to a wireless audio dissemination system.

### BACKGROUND

A wide variety of commercial establishments provide television and/or audio for the enjoyment of their guest and patrons while goods or services are being provided. Health clubs, for example, provide their members with various items of exercise equipment, including cardio equipment, such as treadmills, stairclimbers, elliptical trainers, and stationary bicycles. Users of such equipment may enjoy entertainment while exercising. For example, users may operate mobile audio devices for listening music or enjoying other forms of entertainment, either stored on the device or via radio broadcasts (e.g. AM and/or FM). In addition, health clubs may also provide a series of television monitors mounted throughout the club. These monitors can be tuned to several different television channels and the corresponding audio for each television channel can be broadcast using short range transmitters on unused broadcast radio frequencies. Members can use their mobile audio device to tune into the corresponding radio frequency for the television monitor that they were watching.

Television audio dissemination systems have been enhanced by utilizing audio receivers with volume and channel selectors built-in. These audio receivers may be retrofitted to the cardio equipment. The receivers may also include standard headphone jacks, thereby requiring a user to provide only their own headphones, as opposed to a mobile audio device, to listen the audio corresponding to a selected television monitor. The user is able to select the audio channel and/or adjust the volume by using the controls on the receiver. Typically, the receiver would display a monitor number which would be matched up with the same numbered monitor showing the television program that the user was interested in watching.

Recent consumer electronics have made enormous strides in both size and price reduction while at the same time increasing technical capabilities. One of the most popular consumer electronic devices is a Portable Media Player (PMP). This is a device that is capable of storing and playing digital media such as audio, images, video, documents, etc. It has become common for health club members to use PMPs when exercising.

Another recent advancement in portable consumer electronics is the smartphone. A smartphone is a mobile phone that offers computing ability and connectivity. Smartphones are able to run complete operating system software providing a platform for application developers. Some smartphones can function as a video camera, camera phone with text messaging, a PMP, and an Internet client with e-mail, web browsing, and both Wi-Fi and 3G and/or 4G connectivity. Gym members may use their smartphone as a PMP when exercising.

Commercial establishments have generally not kept pace with these advancements in consumer electronics. For example, a health club member may use his PMP, such as the smartphone, to listen to customized content while exercising at the health club. Additionally, the member may wish to listen to the audio content of a program on a corresponding television monitor at the club. In order to listen to the content on his PMP, as well as the audio content of the program on the television monitor, the club member must switch his headphones back and forth between his PMP's headphone jack and the headphone jack provided on the club's audio equipment. This can quickly become an annoyance to the club member. The audio receiver equipment may also be subject to high use, resulting in a high breakdown rate, requiring repair and/or replacement.

Additionally, some television audio dissemination systems at health clubs place a physical limitation on the areas in which a club member may listen to the audio content of programs on television monitors. In such systems, for example, in order for a club member to listen to the audio content of a program on a corresponding television monitor, he or she must use, or, at the very least, be in close proximity to, cardio equipment fitted with an audio receiver since the system requires that they plug their headphones into the audio receiver. Thus, in some areas of the club, e.g. in a free-weight, cardio room, locker room, entry-way, etc., the audio content of a program may be inaccessible.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a block diagram of one exemplary embodiment of a wireless audio dissemination system consistent with the present disclosure;

FIG. 2 is a schematic illustration of wireless communication utilized in the wireless audio dissemination system of FIG. 1;

FIG. 3 is a view of the mobile device utilized in the wireless audio dissemination system of FIG. 1; and

FIG. 4 is a block flow diagram of one exemplary method consistent with the present disclosure.

### DETAILED DESCRIPTION

The present disclosure is generally directed to a system and method of wireless audio dissemination. In general, a wireless audio dissemination system consistent with the present disclosure includes a plurality of television monitors coupled to a media source including audio and video content, wherein each of the plurality of television monitors is configured to display video content from the media source. The system also includes a plurality of transmitters coupled to the plurality of television monitors, wherein each of the plurality of transmitters is coupled and corresponding to at least one of the plurality of television monitors. Each of the plurality of transmitters is configured to propagate a wireless broadcast stream including audio content associated with video content displayed on a corresponding television monitor.

The system further includes at least one mobile device configured to wirelessly communicate with each of the plurality of transmitters and to wirelessly receive the wireless broadcast stream from each of the plurality of transmitters. The mobile device includes a software application providing a user interface, the software application is configured to identify each of the plurality of transmitters. The user interface allows a user to select one of the identified transmitters from which to receive audio content via the wireless broadcast stream. The mobile device is further configured to aurally reproduce audio content received from the selected transmitters.

A wireless audio dissemination system consistent with the present disclosure may be implemented in various settings and/or locations where widespread wireless dissemination of audio content is desired. For instance, in certain settings it is beneficial to enable patrons to enjoy television programming and other forms of audio/video (A/V) content on mobile devices, regardless of location and without dependence on physical connections. In particular, the system may be implemented in a health club having mounted television monitors throughout the facility. A health club member may use their mobile device to selectively receive audio content that corresponds to the program that is being shown on one of television monitors that the member is viewing. The mobile device has a mobile application stored thereon that, when executed, is configured to allow the health club member to select which audio content they wish to listen to corresponding to the television monitor they are viewing. Unlike the previously described systems, however, a system consistent with the present disclosure allows the user to access audio content wirelessly on their mobile device, as opposed to a fixed audio receiver, giving the user more freedom to enjoy audio content throughout the health club space.

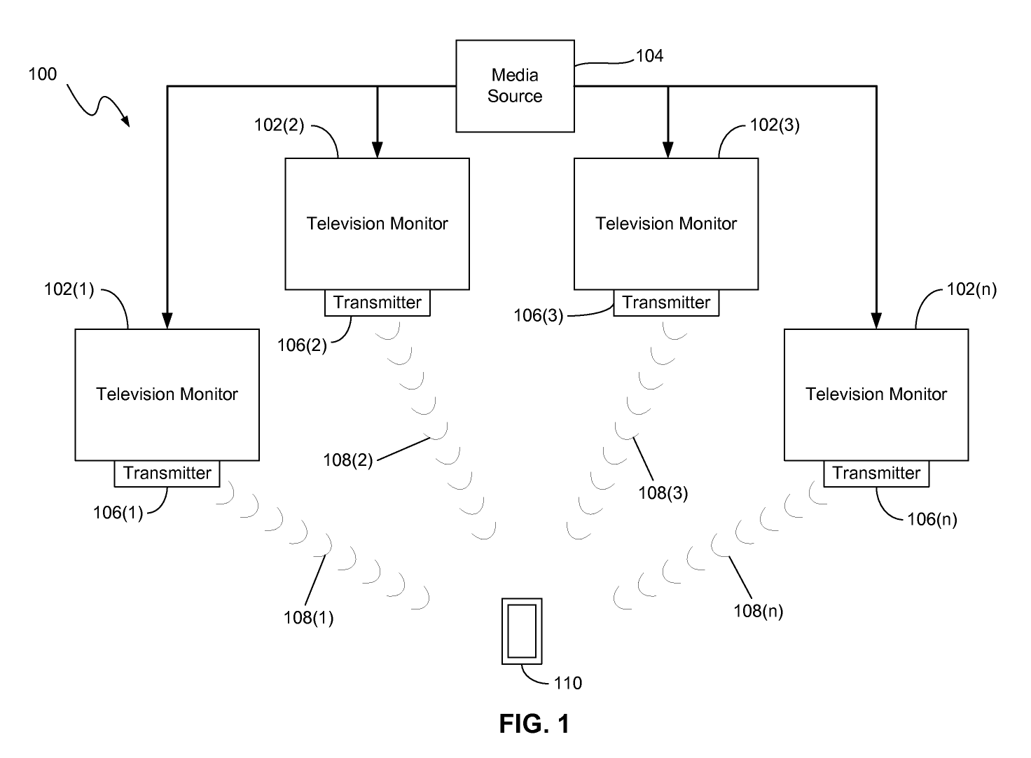

FIG. 1 is a block diagram of one exemplary embodiment of a wireless audio dissemination system consistent with the present disclosure. The wireless audio dissemination system 100 includes a plurality of television monitors 102(1), 102(2), 102(3), . . . , 102(n) coupled to a media source 104 configured to provide audio and video content to the television monitors 102(1), 102(2), 102(3), . . . , 102(n). For ease of description, an individual television monitor that may be any of the plurality of television monitors will be referred to herein as “television monitor 102”. Each television monitor 102 may be configured to display video content from the media source 104.

The system 100 further includes a plurality of transmitters 106(1), 106(2), 106(3) . . . 106(n) coupled to the plurality of television monitors 102(1)-102(n), wherein each of the plurality of transmitters 106(1)-106(n) is coupled to and corresponds to an associated one of the plurality of television monitors 102(1)-102(n). Each transmitter 106(1)-106(n) may be configured to propagate a wireless broadcast stream 108(1)-108(n) including audio content associated with video content displayed on a corresponding television monitor 102. Similarly, for ease of description, an individual transmitter that may be any of the plurality of transmitters will be referred to herein as “transmitter 106” and an individual wireless broadcast stream that may be any of the plurality of broadcast streams 108(1)-108(n) will be referred to herein as “wireless broadcast stream 108”.

In the illustrated embodiment, the system 100 further includes at least one mobile device 110 configured to wirelessly communicate with each transmitter 106 and wirelessly receive the wireless broadcast stream 108 from each transmitter 106. The mobile device 110 may include a software application (also referred to as “app”) stored thereon. When executed by a processor in the mobile device, the software application provides a user interface and may be configured to identify each transmitter 102 of the plurality of transmitters 102(1)-102(n). The user interface is configured to allow a user to select a transmitter 102 from which the user desires to receive audio content via a wireless broadcast stream 108. Upon receiving a wireless broadcast stream 108, the mobile device 110 is configured to aurally reproduce audio content received from the transmitter 106. The process of identifying and selecting a transmitter 106 from which to receive audio content will be described later herein.

It should be noted that in other embodiments, the system 100 may include a single transmitter, as opposed to a plurality of transmitters. The single transmitter, such as transmitter 102(1), may be coupled to the plurality of television monitors 102(1)-102(n) and configured to propagate a plurality of wireless broadcast streams 108(1)-108(n), each of the plurality of wireless broadcast streams 108(1)-108(n) corresponding to an associated one of the plurality of television monitors 102(1)-102(n). Additionally, the at least one mobile device 110 may be configured to wirelessly communicate with the single transmitter and wirelessly receive at least one of the plurality of wireless broadcast streams 108(1)-108(n) from the single transmitter. The software application of the mobile device 110 may provide a user interface and may be configured to identify the single transmitter and each of the plurality of wireless broadcast streams 108(1)-108(n).

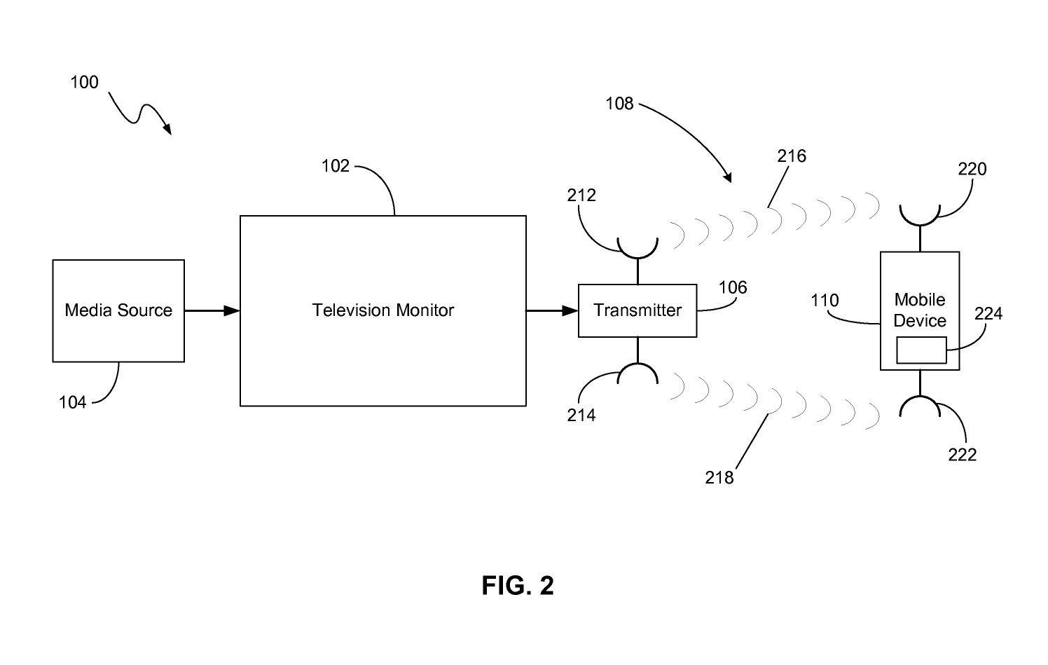

FIG. 2 is a schematic illustration of wireless communication utilized in the wireless audio dissemination system 100 of FIG. 1. In the illustrated embodiment, each television monitor 102 is coupled to a media source 104, which provides audio and/or video content. The media source 102 may include a selectable variety of consumer electronic devices, including, but not limited to, a personal computer, a video cassette recorder (VCR), a compact disk/digital video disk device (CD/DVD device), a cable decoder that receives a cable TV signal, a satellite decoder that receives a satellite dish signal, and/or a media server configured to store and provide various types of selectable programming. The media source 104 may provide any type of information, including video, audio, and/or data sources that may be formatted in any compatible or appropriate format.

As described previously, each transmitter 106 may be coupled to an associated television monitor 102 and be configured to receive an audio signal from the television monitor 102 corresponding to the video content displayed on the television monitor 102. In one embodiment, the transmitter 106 may receive an analog audio signal and convert the analog audio signal to a digital audio signal. Each transmitter 106 is further configured to transmit the audio signal to a mobile device 110 via a wireless broadcast stream 108.

In the illustrated embodiment, each transmitter 106 may include a first and a second wireless communication circuitry 212, 214 configured to provide wireless communication between the each transmitter 106 and the mobile device 110. The first wireless communication circuitry 212 may be configured to propagate a wireless network broadcast 216. It should be noted that, in another embodiment where the system 100 includes a single transmitter, the first wireless communication circuitry 212 may be configured to propagate a plurality of wireless network broadcasts. The wireless network broadcast 216 may include any wireless network that facilitates communications from one communication device to another or to another network such as the Internet. The wireless network broadcast 216 may include, but is not limited to, a WiFi, WiMax, any one of the 802.1x standards, and/or Bluetooth network.

In the illustrated embodiment, the first wireless communication circuitry 212 may be WiFi enabled, permitting wireless communication according to one of the 802.1x standards. Other wireless network protocols standards could also be used, either in alternative to the identified protocols or in addition to the identified protocol. Other network standards may include Bluetooth, the Global System for Mobile Communications (GSM), code division multiple access (CDMA), and long-term evolution (LTE) based wireless protocols. The second wireless communication circuitry 214 may be configured to propagate an AM and/or FM radio signal broadcast 218. The second wireless communication circuitry 214 of each transmitter 106 may be tuned to a locally available, that is, unused FM frequency, where each transmitter 106 is tuned to a different locally available frequency.

In the illustrated embodiment, the mobile device 110 is configured to wirelessly communicate with each transmitter 106 via the wireless broadcast stream 108 propagated by each transmitter 106. The mobile device 110 may include any personal electronic device capable of wireless communication, particularly with each transmitter 106. Certain mobile devices, e.g., cellular telephones, include wireless transceivers capable of exchanging data with a public land mobile network (PLMN) or wireless data network that may be linked with the Internet or other data networks. Other media devices are capable of interfacing with personal area networks (PAN), wireless local area networks (WLAN), satellite data networks (SAN), and other data networks including, for example, WiFi (802.x) networks. The mobile device 110 may include, but is not limited to, a mobile phone, smartphone, PMP, personal digital assistant (PDA), netbook, personal computer (PC), and/or handheld electronic device.

In the illustrated embodiment, the mobile device 110 may include a first wireless communication circuitry 220 configured to communicate with the wireless network broadcast 216 and wirelessly receive audio content carried on the wireless network broadcast 216. The first wireless communication circuitry 220 of the mobile device 110 may be WiFi enabled, permitting wireless communication according to one of the 802.1x standards. Additionally, the mobile device 110 may be enabled to communicate with each transmitter 106 over other network standards, such as Bluetooth, the Global System for Mobile Communications (GSM), code division multiple access (CDMA), and long-term evolution (LTE) based wireless protocols.

Additionally, the mobile device 110 may include a second wireless communication circuitry 222 configured to communicate with the AM and/or FM radio signal broadcast 218 and wireless receive audio content carried on the AM/FM radio signal broadcast 218. In the illustrated embodiment, the second wireless communication circuitry 222 may include a radio tuner and/or radio broadcast receiver capable of receiving the AM/FM broadcast 218.

The first and second wireless communication circuitry 220, 222 may be further configured to receive audio signals from each transmitter 106 via the wireless network broadcast 216 and/or AM/FM radio signal broadcast 218. In one embodiment, the first wireless communication circuitry 220 may be configured to request and retrieve a network address of each transmitter 106 propagating a wireless network broadcast 216 via a network signal provided by each transmitter 216 in the wireless network broadcast 216. The first circuitry 220 may further be configured to establish a data connection with each transmitter 106 and receive audio signals from each transmitter 106 via the network signal from each transmitter 106. Additionally, the second wireless communication circuitry 222 may be configured to tune into the specific frequency carried in the AM/FM broadcast 218 of each transmitter 106. Upon being tuned into the specific frequency, the second circuitry 222 may receive audio signals from each transmitter 106.

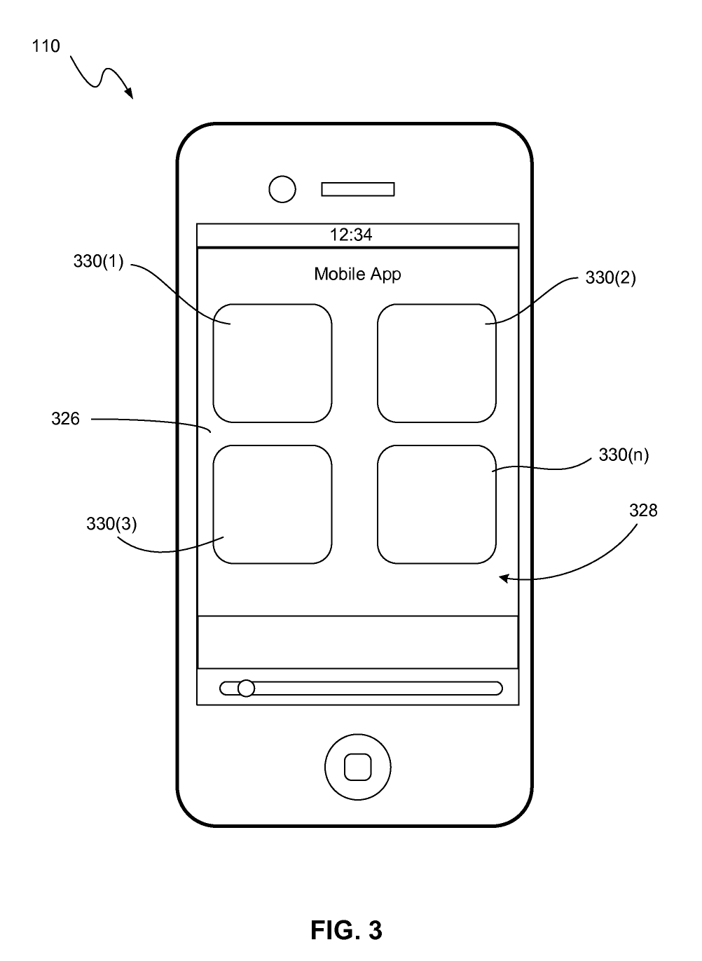

FIG. 3 is a view of the mobile device utilized in the wireless audio dissemination system of FIG. 1. As described earlier, the mobile device 110 may include a wireless communication device such as a cellular telephone, satellite telephone, cordless telephone, personal digital assistant (PDA), portable computer, or any other device capable of wireless communications. In the illustrated embodiment, the mobile device 310 is an exemplary smartphone, and in particular, an Apple® iPhone® available by Apple Inc., of Cupertino, Calif. It should be noted that alternative types of mobile devices 110 may include, for example a Blackberry™, Droid™, i-Pad™, notebook computer, desktop personal computer, and/or netbook computer.

In the illustrated embodiment, the mobile device 110 includes a display 326, which may show and image, including, for example a music video, a movie, video clip, or like video images. In the illustrated embodiment, the mobile device 110 may include a software application stored in a storage medium 224 (FIG. 2) thereon, such as memory. The mobile device 110 user may execute the software application, also known as an “app” on a mobile device 110. The “app” may be available for download at digital distribution platforms for mobile devices, where the platforms are intended to provide mobile software to mobile devices. Examples of digital distribution platforms include, but are not limited to, Apple® iTunes, Android™ Market, etc. When executed, the “app” may include a graphical user interface (GUI) 328 shown on the display 326, wherein the GUI 328 may enable the user to interact with the mobile device 110. Personal computing devices and/or media devices of this type may include a touch screen control. In other embodiments, the GUI 328 can take a variety of forms, such as a button, keypad, dial, a click wheel, and/or a scroller. The GUI 328 may be configured to identify each transmitter 106 propagating a wireless broadcast stream 108. The GUI 328 may further allow the mobile device 110 user to select an identified transmitter 106 from which to receive audio content via the wireless broadcast stream 108.

When a user of the mobile device 300 enters a health club equipped with a system consistent with the present disclosure, such as system 100 of FIGS. 1 and 2, the user may wish to listen to audio content of a program shown on a particular television monitor 102. As shown in FIG. 1, however, there may be a plurality of transmitters 106(1)-106(n), each propagating wireless broadcast streams 108(1)-108(n) carrying audio content corresponding to visual content displayed on the corresponding television monitors 102(1)-102(n). In one embodiment, each transmitter 106 includes the first wireless communication circuitry 212 configured to propagate the wireless network broadcast 216. In the illustrated embodiment, the first wireless communication circuitry 212 is WiFi enabled, permitting wireless communication according to one of the 802.1x standards. Additionally, the mobile device 110 includes the first wireless communication circuitry 220 being WiFi enabled, thereby permitting communication between each transmitter 106 and the mobile device 110 via the wireless network broadcast 216.

When the “app” is executed by the user, the first wireless circuitry 220 of the mobile device 110 is configured to receive the wireless network broadcast 216 from each transmitter 106. The “app” is further configured to identify each transmitter 106 via the wireless network broadcast 216, wherein each wireless network broadcast 216 from each transmitter 106 may include an identifier, such as a network address, specific to each transmitter 106. For example, transmitter 106(1) has a unique network address different from a network address of transmitter 106(2) or transmitter 106(3) and so on. The first wireless communication circuitry 220 may be configured to request and retrieve the network address included in each wireless network broadcast 216 of each transmitter 106.

Upon reception of the network address of each transmitter 106, the GUI 328 of the display 326 may depict selection inputs 330(1)-330(n), each selection input 330 corresponding to an identified transmitter 106. For example, selection inputs 330(1)-330(n) correspond to identified transmitters 106(1)-106(n), respectively. Each selection input 330 may be configured to enable the mobile device 110 user to select the identified transmitter 106 from which to receive audio content corresponding to programming displayed on the television monitor 102 they are viewing. In the illustrated embodiment, the user may be viewing a program displayed on television monitor 102(2). In order to listen to the corresponding audio content, the user may select selection input 330(2) corresponding to identified transmitter 106(2) coupled to television monitor 102(2). Upon selection of selection input 330(2), the first circuitry 220 of the mobile device 110 is configured to establish a data connection with selected transmitter 106(2) and receive audio signals via the wireless broadcast stream 108(2). Upon reception of audio signals, the mobile device 110 is configured to aurally reproduce the received audio content and allow the user to listen to the audio content corresponding to television monitor 102(2).

It should be noted that, in another embodiment where the system 100 includes a single transmitter, upon execution of the “app”, the first wireless communication circuitry 220 of the mobile device 110 may be configured to receive a plurality of wireless broadcast streams from the single transmitter and the “app” may be further configured to identify each wireless broadcast stream. Additionally, the selection inputs 330(1)-330(n) displayed on the display 326 of the mobile device 110 may correspond to an identified wireless broadcast stream, wherein the user may select the identified wireless broadcast stream from which to receive audio content corresponding to programming displayed on a television monitor associated with the selected wireless broadcast stream.

It should also be noted that each transmitter 106 is configured to simultaneously transmit audio content to a plurality of mobile devices. For example, there may be multiple health club members present at the health club. Each member may have a mobile device consistent with the present disclosure. More than one user may wish to listen to the audio content from the same television monitor, such as television monitor 102(1). Multiple users with mobiles devices are able to communicate with and select the same transmitter from which to receive audio content. For instance, transmitter 106(1) coupled to television monitor 102(1) is configured to simultaneously communicate with and transmit audio content corresponding to the program displayed on television monitor 102(1) to more than one mobile device at the same time.

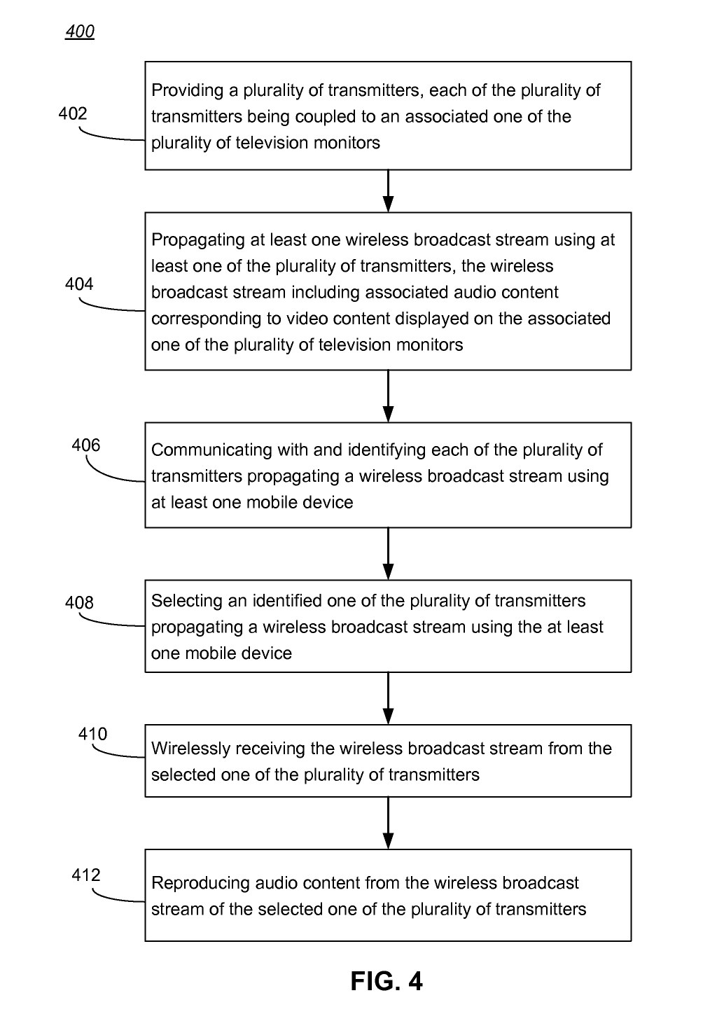

FIG. 4 is a block flow diagram of one method 400 of wireless audio dissemination consistent with the present disclosure. The illustrated block flow diagram may be shown and described as including a particular sequence of steps. It is to be understood, however, that the sequence of steps merely provides an example of how the general functionality described herein can be implemented. The steps do not have to be executed in the order presented unless otherwise indicated.

Referring to FIG. 4, a method 400 of wirelessly disseminating audio content associated with video content displayed on a plurality of television monitors is illustrated. In the exemplary embodiment, each of the plurality of television monitors is coupled to a media source providing audio and video content. A plurality of transmitters is provided 402, wherein each of the plurality of transmitters being coupled to an associated one of the plurality of television monitors. At least one wireless broadcast stream is propagated 404 using one of the plurality of transmitters. The wireless broadcast stream may include audio content associated with video content displayed on a corresponding television monitor. At least one mobile device including a software application providing a user interface communicates with and identifies 406 each of the plurality of transmitters propagating a wireless broadcast stream via the software application. One of the plurality of transmitters propagating a wireless broadcast stream is selected 408 using the at least one mobile device via the user interface provided by the software application. The wireless broadcast stream from the selected transmitter is wirelessly received 410 by the at least one mobile device. Audio content from the wireless broadcast stream of the selected transmitter is aurally reproduced 412 on the at least one mobile device.

Embodiments of the methods described herein may be implemented using a processor and/or other programmable device. To that end, the methods described herein may be implemented on a tangible computer readable medium having instructions stored thereon that when executed by one or more processors perform the methods. Thus, for example, mobile device 110 may include a storage medium 224 to store instructions (in, for example, firmware or software) to perform the operations described herein. The storage medium 224 may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

In one aspect, the present disclosure may feature a system for wireless audio dissemination. The system may include a plurality of television monitors coupled to a media source configured to provide audio and video content, wherein each of the plurality of television monitors is configured to display video content from the media source. The system may also include a plurality of transmitters, wherein each of the plurality of transmitters is coupled to an associated one of the plurality of television monitors. Each of the plurality of transmitters is configured to propagate a wireless broadcast stream including associated audio content corresponding to video content displayed on the associated one of the plurality of television monitors. The system may further include at least one mobile device configured to wirelessly communicate with each of the plurality of transmitters and wirelessly receive the wireless broadcast stream from each of the plurality of transmitters. The at least one mobile device may include a software application providing a user interface and being configured to identify each of the plurality of transmitters. The software application may be further configured to allow a user to selectively receive the associated audio content from one of the plurality of transmitters via the wireless broadcast stream and to aurally reproduce the associated audio content.

In another aspect, the present disclosure may feature a method of wirelessly disseminating audio content. The method may include providing a plurality of television monitors coupled to a media source configured to provide audio and video content, each of the plurality of television monitors configured to display video content from the media source. The method may also include providing a plurality of transmitters, each of the plurality of transmitters being coupled to an associated one of the plurality of television monitors. The method may further include propagating at least one wireless broadcast stream using at least one of the plurality of transmitters. The at least one wireless broadcast stream may include associated audio content corresponding to video content displayed on the associated one of the plurality of television monitors.

The method may include communicating with and identifying each of the plurality of transmitters propagating a wireless broadcast stream using at least one mobile device and selecting an identified one of the plurality of transmitters propagating a wireless broadcast stream using the at least one mobile device. The at least one mobile device may include a software application providing a user interface, wherein the software application may be configured to identify each of the plurality of transmitters. Additionally, the user interface may be configured to allow a user to selectively receive the associated audio content from one of the plurality of transmitters. The method may further include wirelessly receiving the wireless broadcast stream from the selected one of the plurality of transmitters and aurally reproducing audio content from the wireless broadcast stream of the selected one of the plurality of transmitters.

In another aspect of the disclosure, there is provided a computer accessible medium having a plurality of instructions stored thereon which, when executed by a processor, cause the processor to perform operations including: wirelessly communicating with a plurality of transmitters via a wireless broadcast stream including associated audio content propagated by each of the plurality of transmitters, each of the plurality of transmitters being coupled to an associated one of a plurality of television monitors, the plurality of television monitors being coupled to a media source configured to provide audio and video content, each of the plurality of television monitors configured to display associated video content from the media source; identifying each of the plurality of transmitters; selectively receiving the associated audio content from a selected one of the plurality of transmitters via the wireless broadcast stream; and aurally reproducing audio content from the wireless broadcast stream of the selected one of the plurality of transmitters.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

What is claimed is:

1. A system for wireless audio dissemination, said system comprising:
a plurality of television monitors coupled to a media source configured to provide audio and video content, each of said plurality of television monitors configured to display video content from said media source;
at least one transmitter coupled to at least one of said plurality of television monitors, said at least one transmitter configured to propagate at least one wireless broadcast stream comprising associated audio content corresponding to video content displayed on said at least one of said plurality of television monitors; and
at least one mobile device configured to wirelessly communicate with said at least one transmitter and wirelessly receive said at least one wireless broadcast stream from said at least one transmitter;
said at least one mobile device comprising a software application providing a user interface and being configured to identify said at least one transmitter and said at least one wireless broadcast stream and allow a user to selectively receive said associated audio content from said at least one transmitter via said at least one wireless broadcast stream and to aurally reproduce said associated audio content.

2. The system of claim 1, wherein said at least one wireless broadcast stream comprises a FM signal.

3. The system of claim 2, wherein said at least one mobile device is FM enabled.

4. The system of claim 1, wherein said at least one wireless broadcast stream comprises a wireless network.

5. The system of claim 4, wherein said wireless network is selected from the group consisting of a WiFi, WiMax, 802.11 compatible, and Bluetooth network.

6. The system of claim 4, wherein said at least one mobile device comprises wireless communication circuitry configured to request and retrieve a network address for each wireless broadcast stream propagated by said at least one transmitter and establish a data connection with said at least one transmitter and receive audio signals from said at least one transmitter via said at least one wireless broadcast stream.

7. The system of claim 1, wherein said user interface provides a visual display on said at least one mobile device, wherein said visual display is configured to depict identities of each wireless broadcast stream identified by said software application.

8. The system of claim 1, wherein an identity of each wireless broadcast stream is determined via a unique identifier specific to each wireless broadcast stream provided in each wireless broadcast stream propagated by said at least one transmitter.

9. The system of claim 1, wherein said at least one mobile device is selected from the group consisting of a mobile phone, smartphone, portable media player (PMP), personal digital assistant (PDA), netbook, personal computer (PC), and handheld electronic device.

10. The system of claim 1, wherein said at least one transmitter is configured to simultaneously transmit audio content from said at least one wireless broadcast stream to a plurality of mobile devices.

11. A method of wirelessly disseminating audio content, said method comprising:
providing a plurality of television monitors coupled to a media source configured to provide audio and video content, each of said plurality of television monitors configured to display video content from said media source
providing a plurality of transmitters, each of said plurality of transmitters being coupled to an associated one of said plurality of television monitors;
propagating at least one wireless broadcast stream using at least one of said plurality of transmitters, said at least one wireless broadcast stream comprising associated audio content corresponding to video content displayed on said associated one of said plurality of television monitors;
communicating with and identifying each of said plurality of transmitters propagating a wireless broadcast stream using at least one mobile device;
selecting an identified one of said plurality of transmitters propagating a wireless broadcast stream using said at least one mobile device;
wirelessly receiving said wireless broadcast stream from said selected one of said plurality of transmitters; and
aurally reproducing audio content from said wireless broadcast stream of said selected one of said plurality of transmitters;
wherein said at least one mobile device comprises a software application providing a user interface and being configured to identify each of said plurality of transmitters and allow a user to selectively receive said associated audio content from one of said plurality of transmitters via said wireless broadcast stream.

12. The method of claim 11, wherein said wireless broadcast stream comprises a wireless network.

13. The method of claim 12, wherein said wireless network is selected from the group consisting of a WiFi, WiMax, 802.11 compatible, and Bluetooth network.

14. The method of claim 12, wherein said at least one mobile device comprises wireless communication circuitry configured to request and retrieve a network address for a wireless broadcast stream of each of said plurality of transmitters and establish a data connection with each of said plurality of transmitters and receive audio signals from each of said plurality of transmitters via said wireless broadcast stream from each of said plurality of transmitters.

15. The method of claim 11, wherein said user interface provides a visual display on said at least one mobile device, wherein said visual display is configured to depict identities of each of said plurality of transmitters identified by said software application.

16. The method of claim 11, wherein an identity of each of said plurality of transmitters is determined via a unique identifier specific to each of said plurality of transmitters provided in said broadcast stream propagated by each of said plurality of transmitters.

17. The method of claim 11, wherein each of said plurality of transmitters is configured to simultaneously transmit audio content from said wireless broadcast stream to a plurality of mobile devices.

18. A computer accessible medium having a plurality of instructions stored thereon which, when executed by a processor, cause the processor to perform operations comprising:
wirelessly communicating with a plurality of transmitters via a wireless broadcast stream comprising associated audio content propagated by each of said plurality of transmitters, each of said plurality of transmitters being coupled to an associated one of a plurality of television monitors, said plurality of television monitors being coupled to a media source configured to provide audio and video content, each of said plurality of television monitors configured to display associated video content from said media source;
identifying each of said plurality of transmitters;
selectively receiving said associated audio content from a selected one of said plurality of transmitters via said wireless broadcast stream; and
aurally reproducing audio content from said wireless broadcast stream of said selected one of said plurality of transmitters.

19. The computer accessible medium of claim 18, further comprising instructions for determining an identity of each of said plurality of transmitters via a unique identifier specific to each of said plurality of transmitters provided in said wireless broadcast stream propagated by each of said plurality of transmitters.

20. The computer accessible medium of claim 19, further comprising instructions for visually depicting said identity of each of said plurality of transmitters on a mobile device.
